(19) United States
(12) Patent Application Publication
(10) Pub. No.: US 2016/0044275 A1
(43) Pub. Date: Feb. 11, 2016

(54) SINGLE-USE DIGITAL CAMERA

(71) Applicant: Changing International Company Limited, Kowloon (HK)

(72) Inventor: Han-Che CHEN, Taipei City (TW)

(21) Appl. No.: 14/585,601

(22) Filed: Dec. 30, 2014

(30) Foreign Application Priority Data
Aug. 11, 2014 (CN) 201420454572.2

(51) Int. Cl. H04N 5/76; H04N 5/225; H04N 5/232

(52) U.S. Cl. CPC H04N 5/76; H04N 5/23241; H04N 5/2252

(57) ABSTRACT

A single-use digital camera is disclosed. The one-time-use digital camera includes a camera body and a battery cartridge. When the battery cartridge is connected to the camera body, the camera body is activated by the battery cartridge. When the battery cartridge is separated from the camera body or when a predetermined amount of pictures stored in the camera body are downloaded, the camera body is deactivated and the battery cartridge is locked.

### CROSS REFERENCE TO RELATED APPLICATIONS

This Application claims priority of China Patent Application No. 201420454572.2, filed on Aug. 11, 2014, the entirety of which is incorporated by reference herein.

### BACKGROUND OF THE INVENTION

1. Field of the Invention

The invention relates to a digital camera, and more particularly to a single-use digital camera.

2. Description of the Related Art

Traditional disposable film cameras have limited functionality and have gradually faded out of the market since digital cameras become popular. However, the single-use digital cameras are still necessary for users.

### BRIEF SUMMARY OF THE INVENTION

An embodiment of the invention is a single-use digital camera. The one-time-use digital camera comprises a camera body and a battery cartridge. When the battery cartridge is connected to the camera body, the camera body is activated by the battery cartridge. When the battery cartridge is separated from the camera body or when a predetermined a numbert of pictures stored in the camera body are downloaded, the camera body is deactivated and the battery cartridge is locked.

Another embodiment of the invention provides a battery cartridge to connect to the camera body of a single-use digital camera. The battery cartridge comprises a battery and a control circuit. The battery outputs power to the camera body. The control circuit activates the camera body when the battery cartridge is connected to the camera body, and when the battery cartridge is separated from the camera body, the battery cartridge is locked and cannot be used.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a single-use digital camera according to an embodiment of the invention.

FIG. 2 is a back view of a single-use digital camera according to an embodiment of the invention.

FIG. 3 shows the bottom of a single-use digital camera according to an embodiment of the invention.

FIG. 4 is a functional block diagram of a single-use digital camera according to an embodiment of the invention.

FIG. 5 is a functional block diagram of a battery cartridge suited for a single-use digital camera according to an embodiment of the invention.

FIG. 6 is a functional block diagram of a single-use digital camera according to another embodiment of the invention.

FIG. 7 is a functional block diagram of a battery cartridge suited for a single-use digital camera according to another embodiment of the invention.

FIG. 8 is an operation flowchart of a single-use digital camera according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

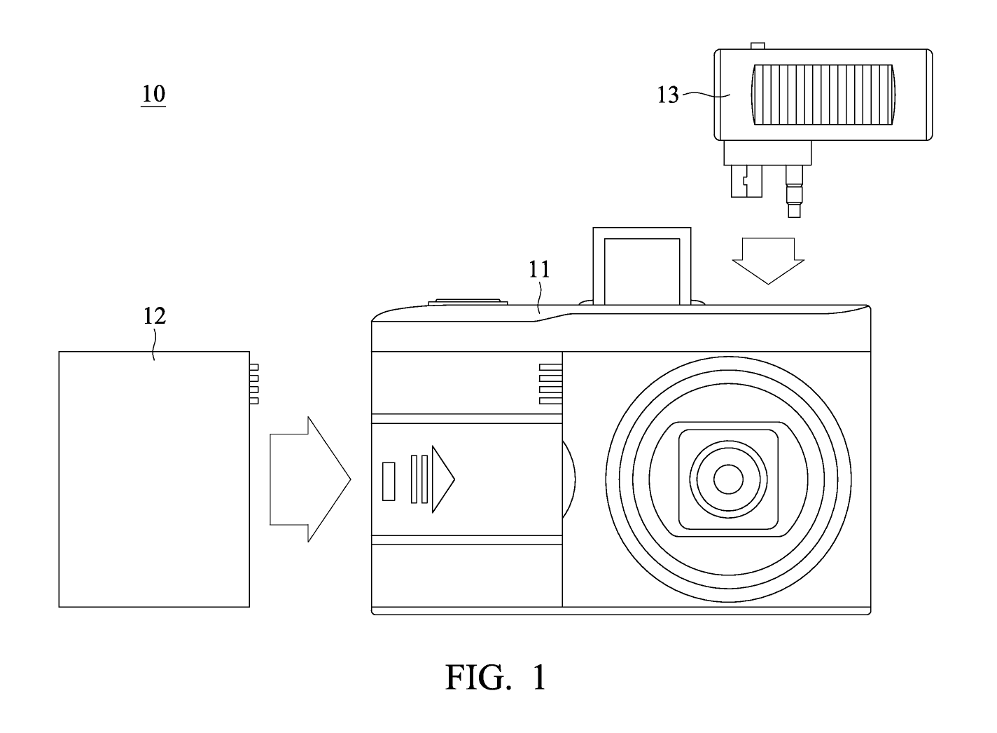

FIG. 1 is a schematic diagram of a single-use digital camera according to an embodiment of the invention. The single-use digital camera 10 comprises a camera body 11, a battery cartridge 12 and a flash 13. The camera body 11 comprises a sealed case and cannot be opened by users. Once the sealed case is opened, the camera body may not function normally. The power required by the camera body 11 is only provided by the battery cartridge 12. The user can buy the camera body 11 and the battery cartridge 12 to take photos.

The camera body 11 comprises a storage device that is capable of storing a constant number of photos. The users choose camera bodies that can store different numbers of images in accordance with their personal needs. In this embodiment, a resolution, dimensions or a number of pixels of each photo by the camera body are the same, and therefore the size of each photo is substantially the same. In another embodiment, the user can choose the resolution, dimensions or the number of pixels of the image taken by the camera body 11. The camera body 11 provides a mechanical selection device for the user to select the resolution, dimensions or the number of pixels of the image. In another embodiment, an operation interface on an LCD panel of the camera body 11 is provided for the user to select the resolution, dimensions or the number of pixels of the image.

In another embodiment, the camera body 11 further comprises a wireless module (not shown in FIG. 1), and the user can download the photos from the camera body 11 to a computer via a wireless transmission.

The flash 13 is optional equipment, not standard equipment, for the single-use digital camera 10. The power required by the flash 13 is only provided by the battery cartridge 12. The flash 13 is connected to the camera body 11 and the battery cartridge 12 provides power to the camera body 11 and the flash 13 simultaneously. The flash 13 is controlled by the controller of the camera body. In another embodiment, the flash 13 provides three luminous intensities that are set by the user or the controller of the camera body 11.

In another embodiment, the flash 13 has a built-in battery and the number of uses of the flash 13 is based on the power of the built-in battery. For example, assuming the number of uses of the flash 13 is 36, then the flash 13 is disabled when the number of uses reaches 36.

When the battery cartridge 12 is connected the camera body 11, the battery cartridge 12 first provides power to the camera body 11, and then a circuit of the battery cartridge 12 communicates, performs a handshake procedure, or exchanges data with the controller of the camera body 11. After communicating, performing the handshake procedure or exchanging data, the circuit activates the camera body 11, and the user can take photos with the single-use digital camera 10. In other words, a photo-shooting function of the camera body 11 is enabled. After the camera body 11 is activated, the circuit of the battery cartridge 12 is locked, and when the user separates the battery cartridge 12 from the camera body 11, the battery cartridge 12 cannot be used anymore until the battery cartridge 12 is reset or re-configured by manufactures. In this embodiment, the number of photos that users can take with the single-use digital camera 10 is set in the circuitry of the camera body 11. In another embodiment, the maximum number of photos that can be shot by the user is set in the circuitry of the battery cartridge 12, and the circuits of the battery cartridge 12 transmit the information to the controller of the camera body 11.

The camera body 11 further comprises a transmission interface and the user downloads the photos stored in the camera body 11 to a computer via the transmission interface. In some embodiments, the transmission interface is a specific interface and only a specific apparatus can access photos from the camera body 11 via the transmission interface. In other words, the specific interface is only compatible with the specific apparatus. The specific apparatus may be provided only to vendors or business entities. After the photos are downloaded from the camera body 11, the camera body 11 is locked and cannot take photos even if the user has not used all the available number of photos. In other words, the photo-shooting function of the camera body 11 is disabled. In another embodiment, the camera body 11 is locked by the controller of the camera body 11. In another embodiment, the camera body 11 is locked by the circuit of the battery cartridge 12. When the battery cartridge 12 is disconnected from the camera body 11, the camera body 11 is locked and the photo-shooting function of the camera body 11 is therefore disabled.

In another embodiment, if the user does not use all the quota of photos of the single-use digital camera 10, the photo-shooting function of the camera body 11 will not be disabled. The user can download the photos from the camera body first, and the photo-shooting function of the camera body 11 will not be disabled until all the quota of photos has been used. For example, assuming the quota of photos of the single-use digital camera 10 is 60 photos, i.e., the camera body can output only 60 photos, the user can first take and output 20 photos and the remaining 40 photos are still available for the user. When the camera takes 60 photos, the photo-shooting function of the camera body 11 is therefore disabled.

The controller of the camera body 11 detects whether the single-use digital camera 10 is used and if the single-use digital camera 10 is not used for a predetermined duration, the controller controls the single-use digital camera 10 to enter a sleeping mode. Until the user presses the shutter button or other buttons on the camera body, the single-use digital camera 10 returns to a working mode.

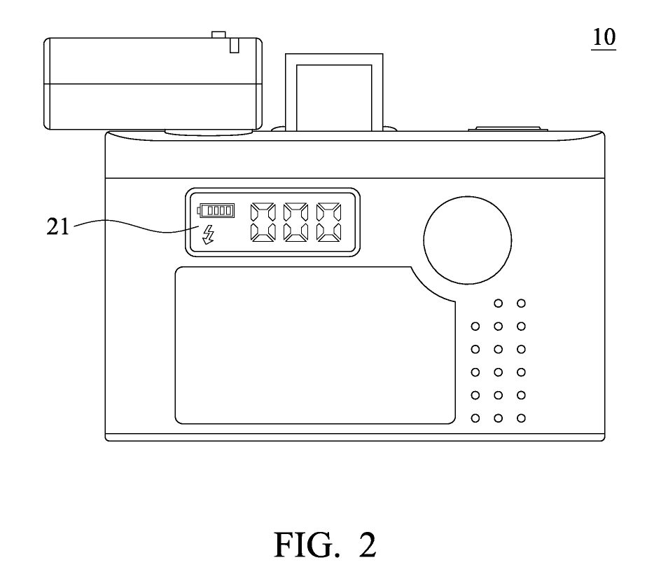

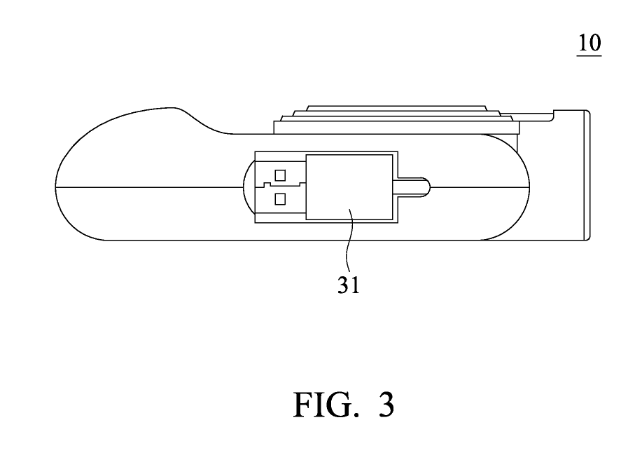

FIG. 2 is a back view of a single-use digital camera according to an embodiment of the invention. The backside of the single-use digital camera comprises an LCD 21 to show the number of photos that can be taken by the user, battery capacity, flash status or other information. FIG. 3 shows a bottom of a single-use digital camera according to an embodiment of the invention. A recess is set in the bottom of the single-use digital camera to accommodate a transmission line 31. The user uses the transmission line 31 to connect to a computer for transmitting the photos from the single-use digital camera to the computer or other storage device. In another embodiment, the transmission line 31 is replaced with a socket. Furthermore, the transmission line 31 or the socket can be disposed on other positions of the single-use digital camera, such as the sides of the single-use digital camera.

The functions described in the single-use digital cameras in FIGS. 1-3 may be equipped in one single-use digital camera or in different single-use digital cameras.

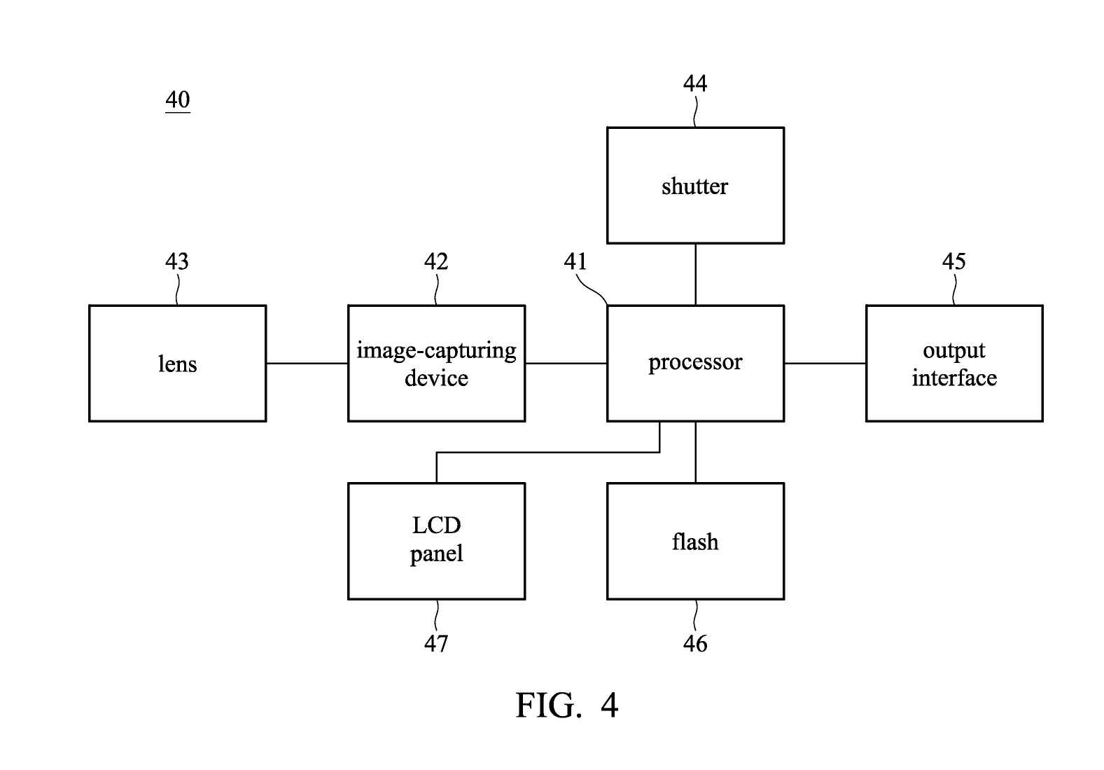

FIG. 4 is a functional block diagram of a single-use digital camera according to an embodiment of the invention. The camera body 40 comprises a processor 41, an image-capturing device 42, a lens 43, a shutter 44, an output interface 45, a flash 46 and an LCD panel 47. Note that the flash 46 is an external device, not a part of the camera body 40. In this embodiment, no power source and no storage medium is embedded in the camera body 40. Only when the camera body 40 is connected to a battery cartridge, the camera body 40 can execute a photo-shooting function. When the camera body 40 is activated by the battery cartridge, the processor 41 executes all operations of the single-use digital camera.

When the user presses the shutter 44, light from a target is focused on the image-capturing device 42, and a captured image is then stored in a storage device of the battery cartridge. The image-capturing device 42 may be a CCD module or a CMOS module. The storage device of the battery cartridge may be a flash memory, a DRAM or a SRAM. In this embodiment, software or firmware executed by the processor 41 has already set a number of photos that can be shot by the user. In another embodiment, when the battery cartridge is connected to the camera body 40, a control circuit of the battery cartridge informs the processor 41 that how many photos can be shot by the user.

The LCD panel 47 is generally set at the back of the single-use digital camera to show the number of photos that can be taken by the user, a battery capacity, a flash status or other else.

When the flash 46 connects to the camera body 40, the flash 46 is powered by the battery cartridge, and a controller of the camera body 40 controls the operation of the flash 46. In one embodiment, the flash 46 has three operations: no flash, low luminous intensity and high luminous intensity. The user or the controller of the camera body 40 can select one of these three operations based on personal needs or ambient light conditions.

The transmission interface 45 is provided to the user for transmitting photos from battery cartridge to the computer. In some embodiments, the transmission interface 45 is a specific interface and is only compatible with a specific apparatus. The specific apparatus can access photos from the camera body 40 via the transmission interface 45. In one embodiment, the specific apparatus may be provided only to vendors or business entities. After the photos are downloaded from the battery cartridge, the camera body 40 is locked and cannot take photos even the user does not use all the quota of photos. In other words, the photo-shooting function of the camera body 40 is disabled. In another embodiment, the camera body 40 is locked by the controller of the camera body 40. In another embodiment, assuming the single-use digital camera is configured to take 50 photos, the processor 41 of the camera 40 disables the photo-shooting function after 50 photos are output from the battery cartridge.

The processor 41 detects whether the single-use digital camera 10 is used and if the single-use digital camera 40 is not operated for a predetermined duration, the processor 41 controls the single-use digital camera 40 to enter a sleeping mode. Until the user presses the shutter or other buttons on the camera body, the single-use digital camera 40 comes back to a working mode.

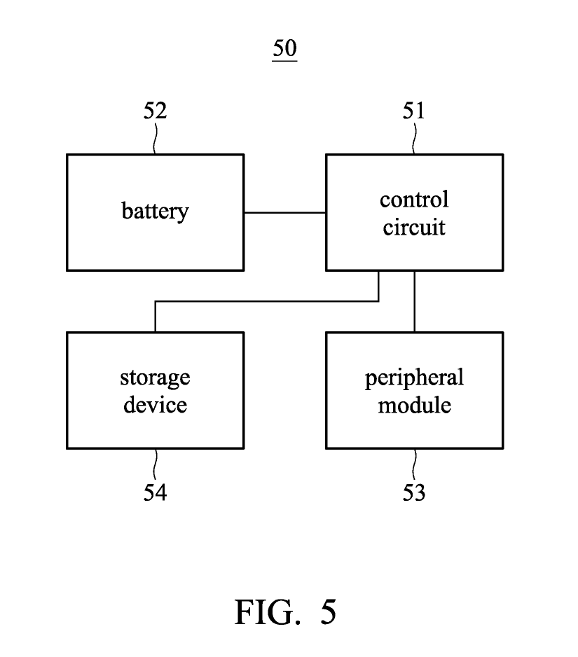

FIG. 5 is a functional block diagram of a battery cartridge compatible with a single-use digital camera according to an embodiment of the invention. The battery cartridge 50 comprises a control circuit 51, a battery 52, a peripheral module 53 and a storage device 54. The peripheral module 53 is optional and is provided by the manufacturer of the battery cartridge 50. The peripheral module 53 is not a standard equipment of the battery cartridge 50. In one embodiment, the control circuit 51 sets a number of photos that can be taken by the single-use digital camera, and the memory size of the storage device 54 is determined according to the number of photos.

When the battery cartridge 50 is connected to the camera body of the single-use digital camera, the control circuit 51 first checks whether the battery cartridge 50 is compatible with the camera body. When the battery cartridge 50 is confirmed to be compatible with the camera body, the control circuit 51 activates the camera body and then the user can use the single-use digital camera to take photos.

The power capacity of the battery 52 is constant, thus, the usage time of the battery cartridge 50 is also constant. The information about the usage time or the power capacity of the battery cartridge 50 is transmitted to the camera body and displayed on a display panel. If the battery cartridge 50 is separated from the camera body, the battery cartridge 50 cannot be used by another camera body. The user only can download photos from the storage device 54 after the battery cartridge 50 is separated from the camera body. After downloading the photos, the photos stored in the storage device 54 are deleted.

In another embodiment, the peripheral module 53 is a data transmission module for providing a wired or a wireless data transmission mechanism. The user uses the peripheral module 53 to output photos from the storage device 54. In another embodiment, the photos stored in the storage device 54 can only output by a transmission interface embedded in the camera body.

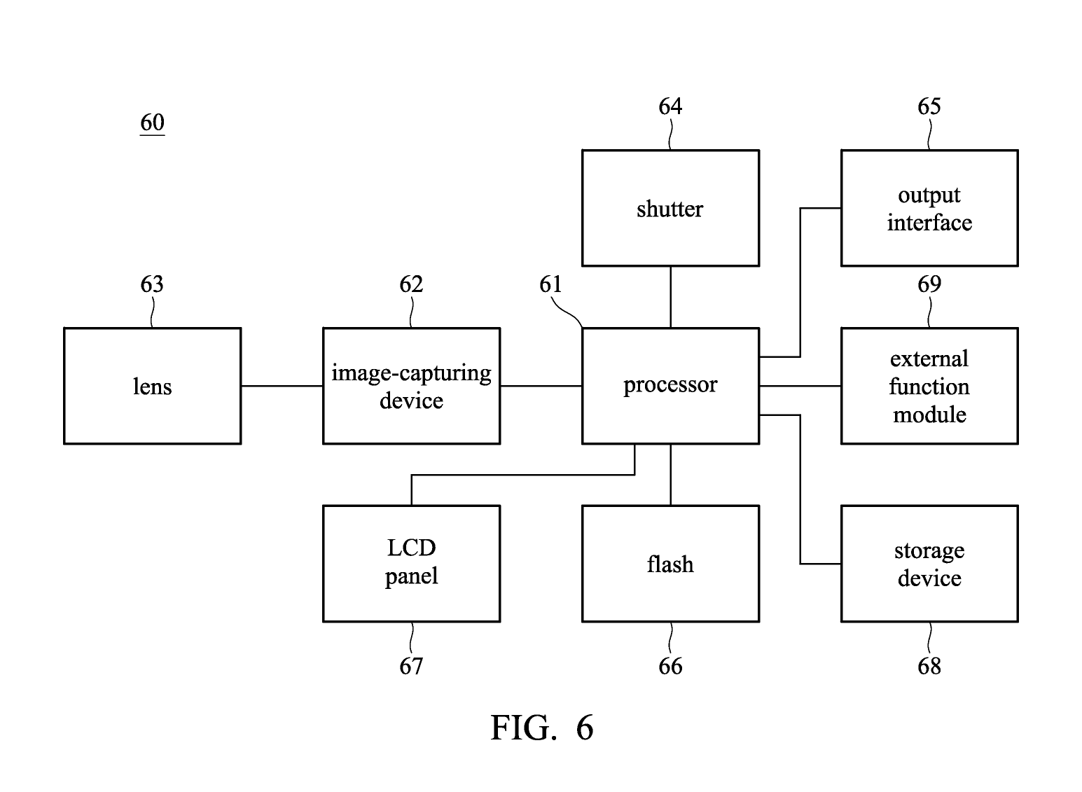

FIG. 6 is a functional block diagram of a single-use digital camera according to another embodiment of the invention. The camera body 60 comprises a processor 61, an image-capturing device 62, a lens 63, a shutter 64, an output interface 65, a flash 66, an LCD panel 67, a storage device 68 and an external function module 69. Note that the flash 66 is an external device, not a fixed part of the camera body 60. In this embodiment, no power source is embedded in the camera body 60. Only when the camera body 60 is connected to a battery cartridge, the camera body 60 can execute a photo-shooting function. When the camera body 60 is activated by the battery cartridge, the processor 61 executes all operations of the single-use digital camera.

When the user presses the shutter 64, lights from a target are focused on the image-capturing device 62, and a captured image is then stored in a storage device 68. The image-capturing device 62 may be a CCD module or a CMOS module. The storage device 68 may be a flash memory, a DRAM or a SRAM. In this embodiment, software or firmware executed by the processor 61 has already set the number of photos that can be shot by the user. In another embodiment, when the battery cartridge is connected to the camera body 60, a control circuit of the battery cartridge informs the processor 61 of how many photos can be shot by user.

The LCD panel 67 is generally set at the back of the single-use digital camera to show the number of photos that can be taken by the user, battery capacity, flash status or other information. In another embodiment, the LCD panel 67 shows an operation interface and the user can use buttons or keys to set parameters for the single-use digital camera, such as image quality, resolution of photos, aperture size, shutter speed, etc. The flash status indicates the flash 66 is turned on, turned off, or in auto mode. The image quality may be high quality, normal quality, or low quality.

When the flash 66 connects to the camera body 60, the flash 66 is powered by the battery cartridge, and a controller of the camera body 60 controls operations of the flash 66. In one embodiment, the flash 66 provides three luminous intensities that are set by the user or the controller of the camera body 60. The external function module 69 may be coupled to circuit modules with different functions or is equipped with the circuit modules with different functions to allow the single-use digital camera more versatile. In one embodiment, the external function module 69 is a wireless network module to directly transmit photos stored in the storage device 68 to a computer via a wireless communication protocol.

The transmission interface 65 is provided to user for transmitting photos from the storage device 68 to the computer. In some embodiments, the transmission interface 65 is a specific interface and is only compatible with specific apparatus. The specific apparatus can access photos from the camera body 60 via the transmission interface 65. In one embodiment, the specific apparatus may be provided only to vendors or business entities. After the photos are downloaded from the storage device 68, the camera body 60 is locked and cannot take photos even the user does not use all the quota of photos. In other words, the photo-shooting function of the camera body 60 is disabled. In another embodiment, the camera body 60 is locked by the processor 61. In another embodiment, the camera body 60 is locked by circuits of the battery cartridge. In another embodiment, if the battery cartridge is separated from the camera body 60 and the photos stored in the storage device 68 are not output, the photos may be lost and are irrecoverable.

The processor 61 of the camera body 11 detects whether the single-use digital camera is operated and if the single-use digital camera is not operated for a predetermined duration, the processor 61 controls the single-use digital camera to enter a sleeping mode. Until the user presses the shutter button or other buttons on the camera body, the single-use digital camera comes back to a working mode.

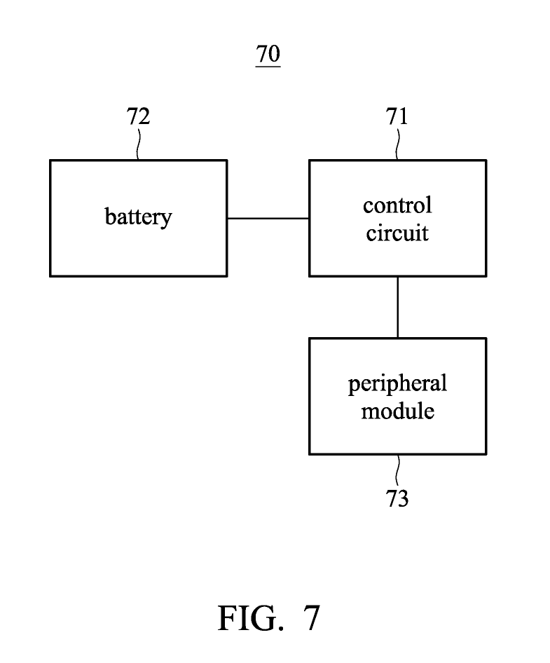

FIG. 7 is a functional block diagram of a battery cartridge compatible with a single-use digital camera according to another embodiment of the invention. The battery cartridge 70 comprises a control circuit 71, a battery 72 and a peripheral module 73. The peripheral module 73 is optional and is provided by a manufacturer of the battery cartridge 70. The peripheral module 73 is not standard equipment of the battery cartridge 70. In one embodiment, the control circuit 71 sets a number of photos that can be taken by the single-use digital camera.

When the battery cartridge 70 is connected to the camera body of the single-use digital camera, the control circuit 71 first checks whether the battery cartridge 70 is compatible with the camera body. When the battery cartridge 70 is confirmed to be compatible with the camera body, the control circuit 71 activates the camera body and then the user can uses the single-use digital camera to take photos.

The power capacity of the battery 72 is constant, thus, the usage time of the battery cartridge 70 is also constant. The information about the usage time or the power capacity of the battery cartridge 70 is transmitted to the camera and displayed on a display panel. If the battery cartridge 70 is separated from the camera body, the battery cartridge 70 cannot be used by other camera bodies unless the battery cartridge 70 is reset by the manufacturer.

In another embodiment, the peripheral module 73 is a data transmission module for providing a wired or wireless data transmission mechanism. When the battery cartridge 70 connects to the camera body of the single-use digital camera, the user accesses the photos stored in the camera body via the peripheral module 73.

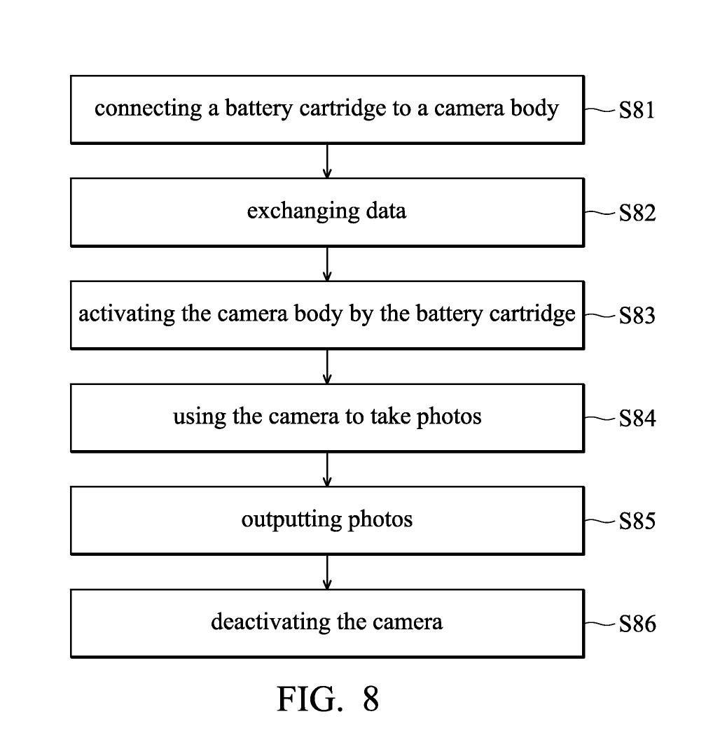

FIG. 8 is an operation flowchart of a single-use digital camera according to an embodiment of the invention. In step S81, the battery cartridge is connected to a camera body of a single-use digital camera. In step S82, circuits of the battery cartridge exchange information or data with a processor or a controller of the camera body, such as security authentication data. In step S83, the battery cartridge and the camera body complete an authentication procedure, and the circuits of the battery cartridge activate the camera body. In step S84, the user uses the single-use digital camera to take photos. In step S85, the user outputs photos stored in the single-use digital camera. In step S86, the camera body is deactivated and cannot be used after the photos are output from the single-use digital camera. In another embodiment, when the battery cartridge is connected to the camera body, the camera body is set to output photos only one time.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A single-use digital camera comprising:
a camera body; and
a battery cartridge, wherein when the battery cartridge is connected to the camera body, the camera body is activated by the battery cartridge; when the battery cartridge is separated from the camera body or when a predetermined number of pictures stored in the camera body are downloaded, the camera body is deactivated and the battery cartridge is locked.

2. The single-use digital camera as claimed in claim 1, wherein power required by the camera body is provided only by the battery cartridge.

3. The single-use digital camera as claimed in claim 1, further comprising a flash connecting to the camera body and being powered by the battery cartridge.

4. The single-use digital camera as claimed in claim 1, wherein the camera body further comprises a transmission interface or a transmission line to output at least one photo from the camera body.

5. The single-use digital camera as claimed in claim 1, further comprising an LCD panel embedded in the camera body to show information about the single-use digital camera.

6. The single-use digital camera as claimed in claim 1, wherein the camera body further comprises a processor to execute operations of the single-use digital camera after the processor is activated when the battery cartridge is connected to the camera body.

7. The single-use digital camera as claimed in claim 1, wherein the camera body further comprises a wireless network module to wireless;ly connect to a computer.

8. The single-use digital camera as claimed in claim 1, wherein the single-use digital camera is limited to taking a first number of photos, a processor of the camera body counts a second number of photos that are output from the camera body, and when the first number is equal to the second number, the camera body is deactivated.

9. The single-use digital camera as claimed in claim 1, wherein the camera body is deactivated by a circuit of the battery cartridge.

10. A battery cartridge to connect to a camera body of a single-use digital camera, comprising:
a battery to output power to the camera body; and
a control circuit to activate the camera body when the battery cartridge is connected to the camera body, and when the battery cartridge is separated from the camera body, the battery cartridge is locked and cannot be used.

11. The battery cartridge as claimed in claim 10, wherein when the battery cartridge is connected to the camera body, the control circuit authenticates the camera body and activates the camera body

12. The battery cartridge as claimed in claim 10, wherein the battery cartridge further comprises a storage device to store photos captured by the camera body.

13. The battery cartridge as claimed in claim 10, wherein the battery cartridge further comprises a wireless network module to wireless connect the camera body to a computer.
